(19) United States
(12) Patent Application Publication
(10) Pub. No.: US 2016/0070858 A1
(43) Pub. Date: Mar. 10, 2016

(54) VISUALIZING GENOMIC DATA

(71) Applicant: KONINKLIJKE PHILIPS N.V., EINDHOVEN (NL)

(72) Inventors: ALEXANDER RYAN MANKOVICH, NEW YORK, NY (US); NEVENKA DIMITROVA, PELHAM MANOR, NY (US)

(21) Appl. No.: 14/842,928

(22) Filed: Sep. 2, 2015

Related U.S. Application Data
(60) Provisional application No. 62/046,322, filed on Sep. 5, 2014.

(51) Int. Cl. G06F 19/26; G06F 19/22

(52) U.S. Cl. CPC G06F 19/26; G06F 19/22

(57) ABSTRACT

Clinical decision support visualization methods that use information, pathways, or inferred regulatory networks for the entire genome, transcriptome, exome, or methylome to highlight genomic activity to further the understanding of the clinical condition of a patient or to contrast different patient groups.

### CROSS-REFERENCE TO PRIOR APPLICATION

This application claims the benefit of U.S. Provisional Application No. 62, 046,322, filed Sep. 5, 2014 which is hereby incorporated by reference.

### FIELD

The invention relates generally to methods and systems for visualizing high-throughput molecular profiling data in general and DNA sequencing data in particular.

### BACKGROUND

Next generation sequencing is at the brink of providing new types of information that were not previously accessible for the diagnosis and prognosis of a particular disease. However, the quantity of this information can be overwhelming due to its depth and resolution.

Prior art visualization techniques have used rectangular heatmaps to display molecular profiles and signatures that have been identified, and yet they often fail to convey the significance to a particular patient, e.g., which cellular pathways are involved. Therefore, these techniques are typically limited in their ability to explain pathology and to help the clinician develop a course of treatment within the realm of available therapy choices. Innovating beyond current visual concepts of these data is also essential. Methods and systems for visualizing genomic data in this regard would simplify a very important aspect of any workflow in this field.

### SUMMARY OF THE INVENTION

This summary is provided to introduce a selection of concepts in a simplified form that are further described below in the Detailed Description section. This summary is not intended to identify key features or essential features of the claimed subject matter, nor is it intended to be used as an aid in determining the scope of the claimed subject matter.

There is a growing amount of molecular information becoming available that can be used for cancer diagnostic and therapy planning purposes. The present invention relates to clinical decision support visualization methods that use information, pathways, or inferred regulatory networks for the entire genome, transcriptome, exome, or methylome to highlight genomic activity to further the understanding of the clinical condition of a patient or to contrast different patient groups. Embodiments of the present invention utilize multiple high-throughput molecular modalities such as gene expression and copy number data measured on the same patient sample.

In one aspect the present invention relates to a method for visualizing genomic data. A function is applied to a plurality of genomic values, the application of the function resulting in a plurality of range values. A value for output purposes is associated with each range value. The associated values for output purposes are then displayed in a graphical representation. In one embodiment, the graphical representation is selected from the group consisting of a karyogram; a chromosome-wide display of RNA-seq expression and methylation data; and a radial heatmap.

These and other features and advantages, which characterize the present non-limiting embodiments, will be apparent from a reading of the following detailed description and a review of the associated drawings. It is to be understood that both the foregoing general description and the following detailed description are explanatory only and are not restrictive of the non-limiting embodiments as claimed.

### BRIEF DESCRIPTION OF DRAWINGS

Non-limiting and non-exhaustive embodiments are described with reference to the following figures in which:

FIG. 1 is a flowchart of a method for analyzing genomic data for visualization in accord with the present invention;

FIG. 2 is an example of a genome-wide expression karyogram generated using the analytic methods of the invention, where the expression levels are depicted as rectangles and the FPKM value shown using a continuous color gradient;

FIG. 3 is an example of a genome-wide expression karyogram generated using the analytic methods of the invention, where the expression data is stratified in cytobands and displayed with cancer-relevant features and the FPKM value is shown by the height of the entry in the cytoband;

FIG. 4 is an example of a chromosome-wide display of RNA-seq expression and methylation data generated using the analytic methods of the invention; the cytoband plot at the top with the white rectangle indicates the whole chromosome is under view, and the corresponding regions of hypermethylation are displayed below; the bottom two tracks show average expression values across HER2+ and HER2− patient cohorts;

FIG. 5 depicts FIG. 4 zoomed in on chromosome 1 to 150 Mb;

FIG. 6 is a radial heatmap of gene expression values within a patient subgroup which was found to respond positively to Herceptin therapy;

FIG. 7 is a radial heatmap of gene expression values within a patient subgroups which was found to be non-responsive to Herceptin therapy;

FIG. 8 is a radial heatmap of the relative values between FIGS. 6 and 7; and

FIG. 9 is a block diagram of an apparatus implementing an embodiment of the present invention.

In the drawings, like reference characters generally refer to corresponding parts throughout the different views. The drawings are not necessarily to scale, emphasis instead being placed on the principles and concepts of operation.

### DETAILED DESCRIPTION

Various embodiments are described more fully below with reference to the accompanying drawings, which form a part hereof, and which show specific exemplary embodiments. However, embodiments may be implemented in many different forms and should not be construed as limited to the embodiments set forth herein; rather, these embodiments are provided so that this disclosure will be thorough and complete, and will fully convey the scope of the embodiments to those skilled in the art. Embodiments may be practiced as methods, systems or devices. Accordingly, embodiments may take the form of a hardware implementation, an entirely software implementation or an implementation combining software and hardware aspects. The following detailed description is, therefore, not to be taken in a limiting sense.

Reference in the specification to “one embodiment” or to “an embodiment” means that a particular feature, structure, or characteristic described in connection with the embodiments is included in at least one embodiment of the invention. The appearances of the phrase “in one embodiment” in various places in the specification are not necessarily all referring to the same embodiment.

Some portions of the description that follow are presented in terms of symbolic representations of operations on non-transient signals stored within a computer memory. These descriptions and representations are the means used by those skilled in the data processing arts to most effectively convey the substance of their work to others skilled in the art. Such operations typically require physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “determining” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions that could be embodied in software, firmware or hardware, and when embodied in software, could be downloaded to reside on and be operated from different platforms used by a variety of operating systems.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The processes and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the present invention as described herein, and any references below to specific languages are provided for disclosure of enablement and best mode of the present invention.

In addition, the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the claims.

In brief overview, embodiments of the present invention address the clinical need for improved diagnostics by providing visualization tools for high-throughput molecular profiling data in general and DNA sequencing data in particular. These embodiments are useful for visualizing the results of statistical analysis of the entire transcriptome, methylome, or exome which can be used to, for example, stratify cancer patients with high sensitivity and specificity, resulting in better patient outcomes, more targeted treatment, and potentially substantial savings in treatment cost.

While many methods exist today for genomic data visualization, quantitative visualization methods that are intuitively understandable by clinicians are less developed. For example, karyograms are often used to represent a whole chromosome structure; however, representing the transcriptional readout for a patient or group of patients as a continuous expression signature spanning a genome-wide scale is believed to be unused. Expression visualization in Circos plots, while aesthetically pleasing, is overly complex and misrepresents the human genome as being circular. Presenting copy number alterations using visualizations of layered tracks of data with the variable being loci along the whole genome, such as the Bergamaschi [1] and Tang [2] studies, is coherent, but the visualization is not intuitive and may require reading the accompanying text to understand what is depicted.

Furthermore, methods for scoring and contextualizing groups of patients or representing a single patient within a cohort are rudimentary at best. In current practice, patients diagnosed with cancer are stratified into groups based on clinicopathological data that determine prognosis (e.g., in terms of time to cancer progression or recurrence), response to, or selection of therapy. The basis for stratification is typically presented as a table or list of markers and clinical data. Classifying patients using the statistical selection of a set of features from high throughput molecular data that jointly differentiate between clinically relevant classes of patients results in just a single score or a list of gene levels. These methods do not explicitly present a single patient's genome or transcriptome for visualization.

For patients that do not clearly fall within the boundaries of a clinical guideline, there is little information that can be elicited from the massive amounts of genomic data generated by next generation sequencing. It is this kind of information, however, that can make the most difference in individualized therapy and improving patient outcome.

Embodiments of the present invention provide visualization methods useful to clinical decision support that use whole genome information, pathways or inferred regulatory networks to highlight genomic activity for understanding the clinical condition of a patient or contrasting different patient groups. These methods utilize multiple high-throughput molecular modalities such as gene expression and copy number data measured on the same patient sample.

Embodiments of the present invention are useful to clinical decision support by analyzing multi-modality molecular profiling data for a single patient utilizing signatures and pathway database resources (such as the National Cancer Institute Pathway Interaction Database, available at http://pid.nci.nih.gov/) and using a pathway visualization engine to provide an intuitive and accurate visual representation of gene activity in a consistent manner. The visual representation utilizes a visual grammar across the genome that can express deviations from normal activity of one or more genes in the context of a biological network or a pathway. These visualizations can take the form of a series of discrete images or a plurality of images aggregated as an animation or video.

In addition, embodiments of the present invention can also be used to display on a genome-wide scale information drawn from one or more inter-related biological pathways from a single patient. These visualizations may help an operator determine, e.g., the inter-relatedness of the genes within the architecture of the patient's genome. Similarly, the average information of a full cohort could be displayed as genome-wide pathway information.

Still other embodiments may be used to visualize genome-wide information across different clinical studies, across patients from different hospitals, or across different regiments of pathway activity levels in patients, and these pathway activity levels can then be used to contextualize a single patient within this larger cohort.

Embodiments of the present invention use mappings of whole transcriptome, methylome and exome data captured by next generation sequencing data and overlay activity levels or differential activity levels of genes as measured from multiple molecular modalities such as copy number and gene expression (i.e., transcriptome) data. Although it is not easy to predict the structure of post-analytical and statistical data; we can assume that clustering areas of interest can significantly reduce the complexity of a genome-wide visualization.

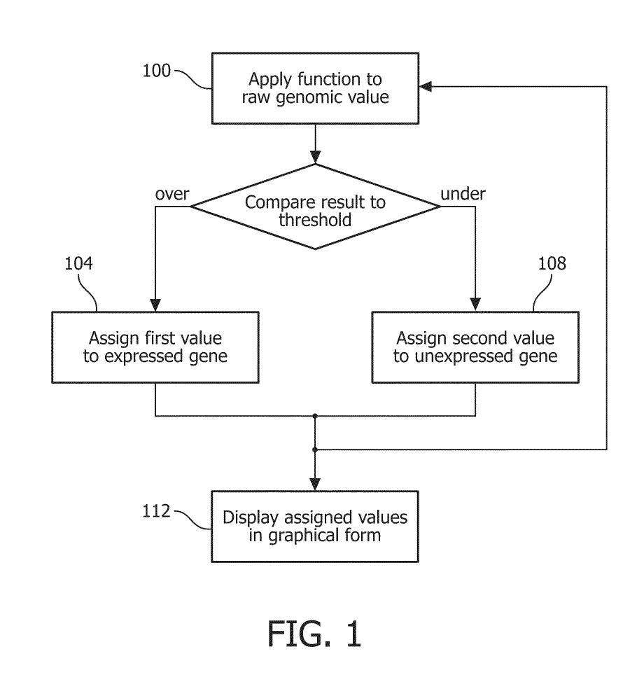

FIG. 1 presents a flowchart for a method for analyzing genomic data for visualization in accord with the present invention. The analysis begins by applying a function to raw genomic data, e.g., fragments per kilobase of transcript per million mapped reads (FPKM) values to determine which genes are expressed and which genes are not expressed (Step 100). In one embodiment, this is a logarithm function with an appropriate base, such as two; other functions or other bases may be used in embodiments of the present invention when the underlying data distribution of the original data space calls for a different type of function or a different basis.

If the result of the function applied to the FPKM value is greater than zero, then it is determined that the gene is expressed (Step 104). To simplify the graphical presentation, the result of the function for all expressed genes can be assigned an equal value, such as one or Boolean true. If the result of the function applied to the FPKM value is less than zero, then it is determined that the gene is not expressed (Step 108). To simplify the graphical presentation, the result of the function for all unexpressed genes can be assigned an equal value, such as −1 or Boolean false.

The results of the function as applied to the FPKM values can then be displayed in a graphical form (Step 112), e.g., with the genomic loci displayed along one axis (such as the x-axis) and the function values depicted by a colored tick or rectangle which can be, e.g., proportionately sized to the length of the corresponding gene. As discussed above, the colors can be displayed in a binary manner corresponding to expressed and unexpressed genes, while other embodiments can display the colors in a continuous range by, e.g., equating the minimum and maximum expression values (e.g., the log₂(FPKM) values) to two color values, establishing a linear mapping between the two colors, and displaying the color that corresponds to the particular expression value.

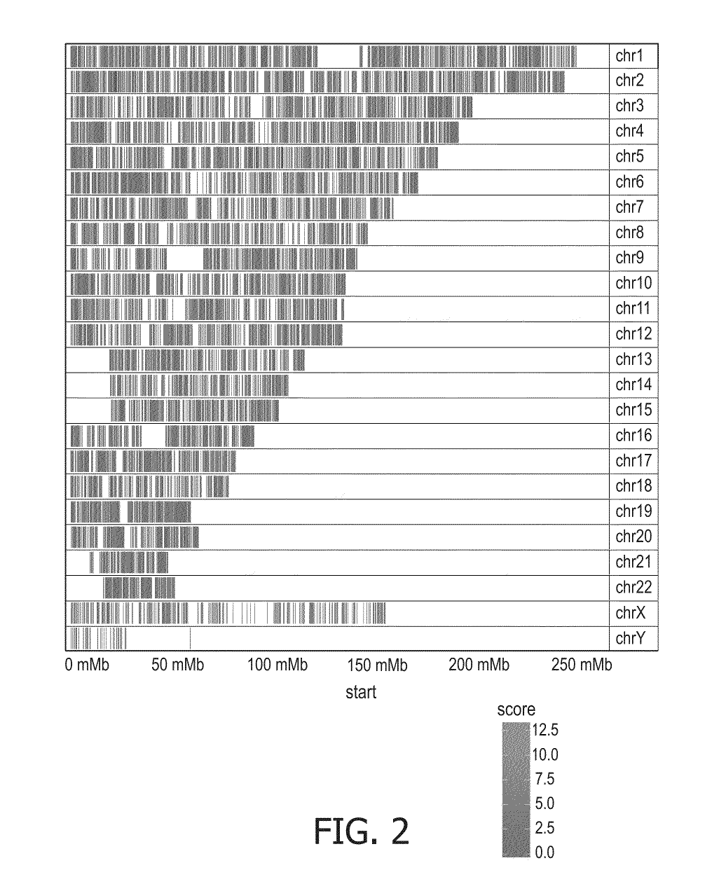

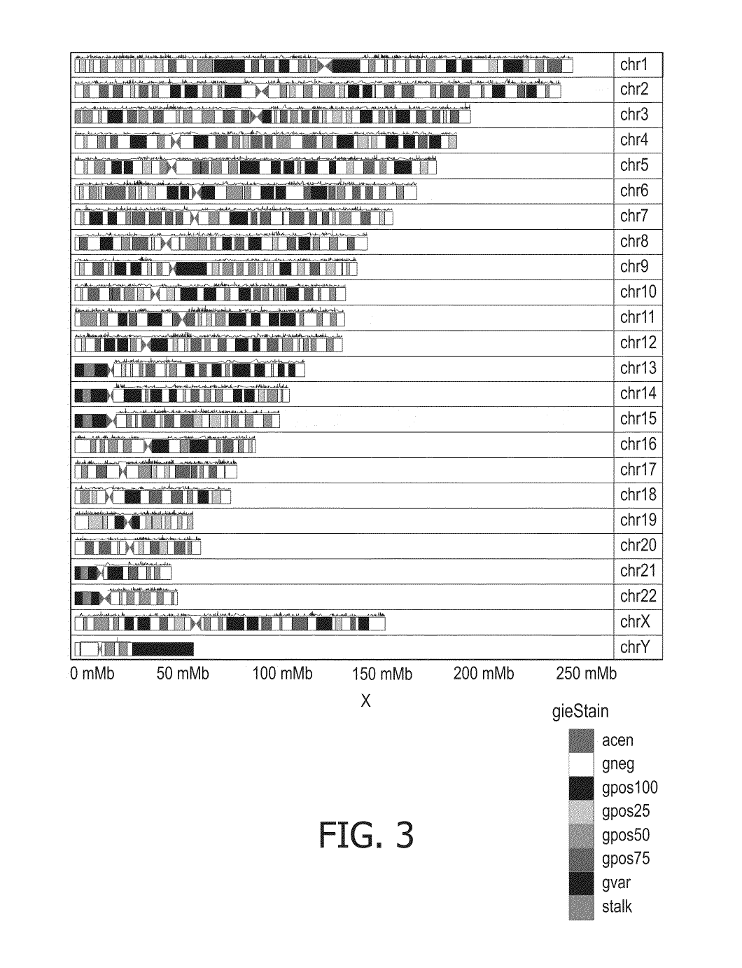

With reference to FIGS. 2 and 3, in some embodiments the present invention relates to the creation and display of genome-wide expression karyograms (i.e., including lncRNAs and genes) by quantizing and displaying whole transcriptome information on a genome-wide scale. FIG. 2 depicts such a karyogram, where the colors of the expression vales (e.g., the log₂(FPKM) values) are displayed in a continuous range, with a legend indicating the minimum and maximum expression values and the correspondence of the colors to the various expression values.

In another embodiment, the results of the function as applied to the FPKM values can be displayed in a graphical form that utilizes a bar or line representation to illustrate the expression values (e.g., the log₂(FPKM) values), as illustrated in FIG. 3. In various embodiments the expression data can be shown by itself (e.g., displayed by chromosome number in ascending or descending order) or stratified with a combination of cytobands and cancer-relevant features such as genes, hypermethylated regions, and CpG islands, as illustrated in FIG. 3.

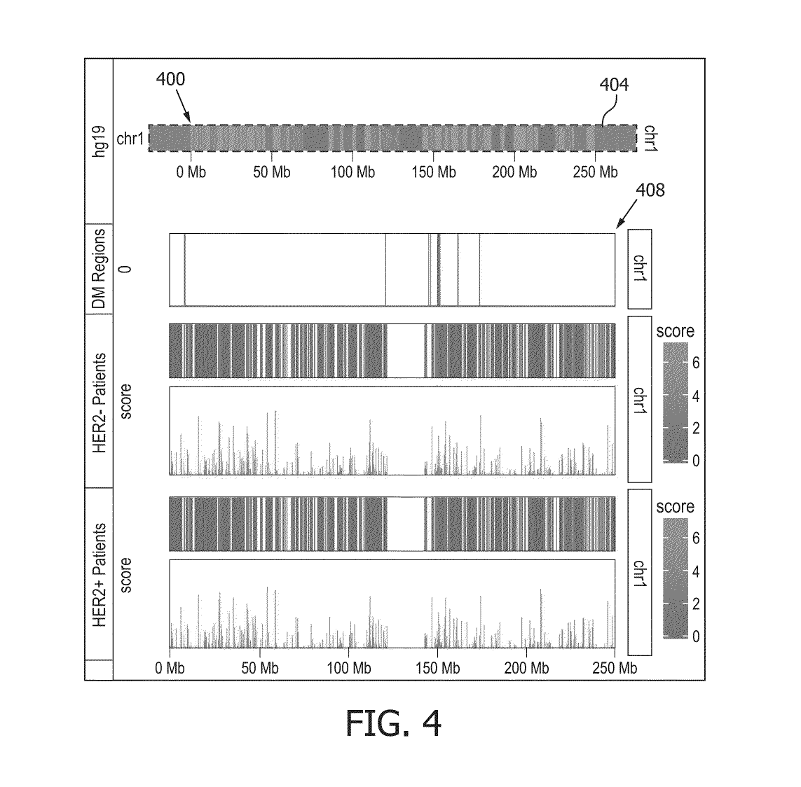

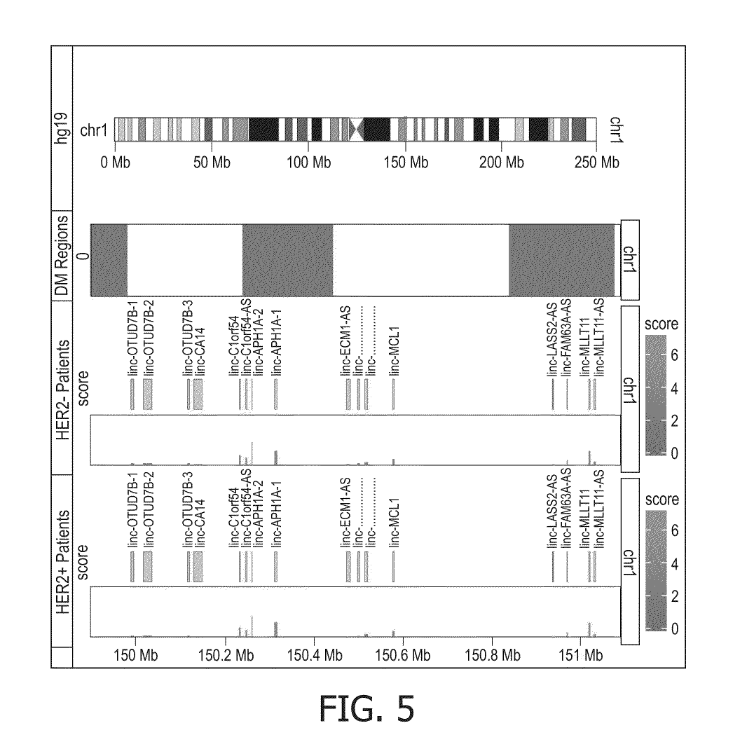

With reference to FIGS. 4 and 5, in some embodiments the present invention relates to the creation and display of chromosome-wide expression and methylation data for a single chromosome. In FIG. 4, a cytoband 400 is displayed for the chromosome of interest along with a translucent rectangle overlay 404 to indicate the zoom region; the translucent rectangle overlay 400 is depicted by white broken lines and coincides with the entire cytoband 400. The display of the cytoband 400 is stratified with displays of hypermethylated regions 408 represented as colored rectangles spanning the region and expression values (e.g., the log₂(FPKM) values) for any number of patients. Some embodiments will display statistical values of the expression data such as mean or variance in lieu of or in addition to displaying the expression value data. Individual expression data values can be displayed using a binary color selection, a continuous color mapping and/or by height in a bar graph, as discussed above, with a legend indicating the minimum and maximum expression values and the correspondence of the colors to the various expression values. The bottom two tracks show average expression values across HER2+ and HER2− patient cohorts.

The display of FIG. 4 is interactive, in that operators may zoom in on certain loci by, e.g., manipulating the transparent overlay 404. The result of zooming in on chromosome 1 to 150 Mb is shown in FIG. 5. Note that the rectangle on the top track has shrunk to fit the zoom level and the bottom two tracks now display gene/lncRNA names next to the expression values.

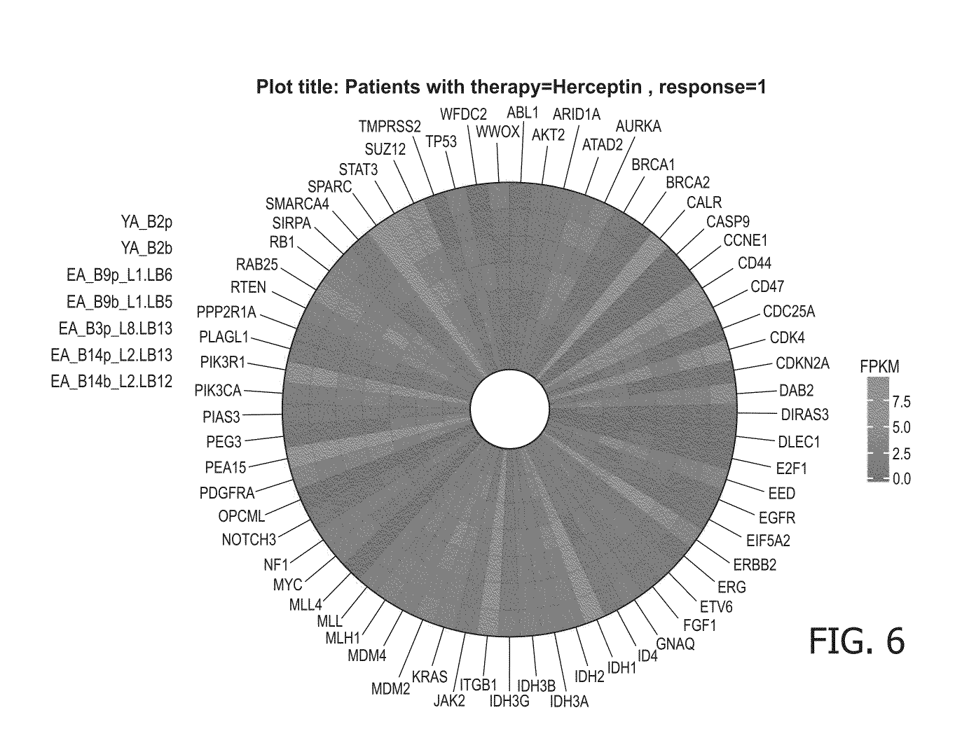

With reference to FIGS. 6-8, in some embodiments the present invention relates to the creation and display of circular heat maps of patient subgroup expression data. The process begins by collecting gene expression data for a particular list of lncRNAs or genes for an individual or group of patients as discussed above in connection with FIG. 1.

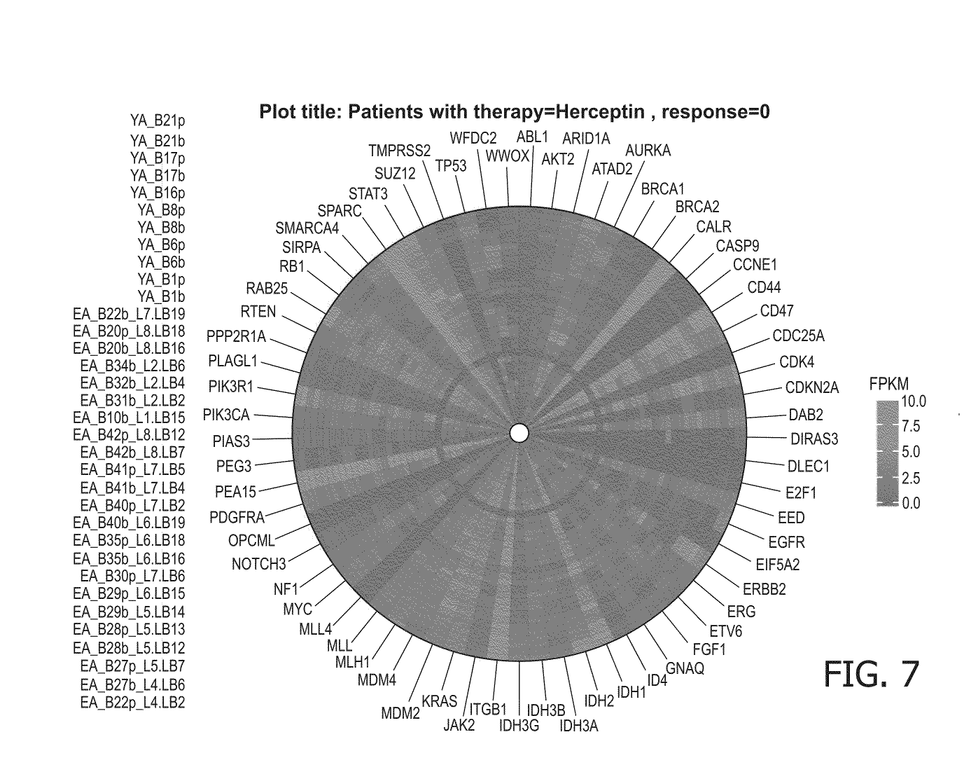

As illustrated in FIGS. 6 and 7, that collected expression data can be depicted as a ring-like one-dimensional heat map where each ring in the map represents a patient, each spoke in the map represents a gene, and the color of an individual cell in the map corresponds to the expression value of a particular gene in a particular patient. Multiple patients can be selected by common clinical factors (such as tumor subtype, therapy used, and response to therapy, etc.) and their heat maps stratified in a circular fashion growing outwards.

As discussed above, individual expression values can be displayed using a binary color selection or a continuous color mapping, e.g., where the gene's expression value (e.g., the log₂(FPKM) value) is represented on a continuous scale between RGB=(0,0,256) and RGB=(256,0,0), with a legend indicating the minimum and maximum expression values and the correspondence of the colors to the various expression values.

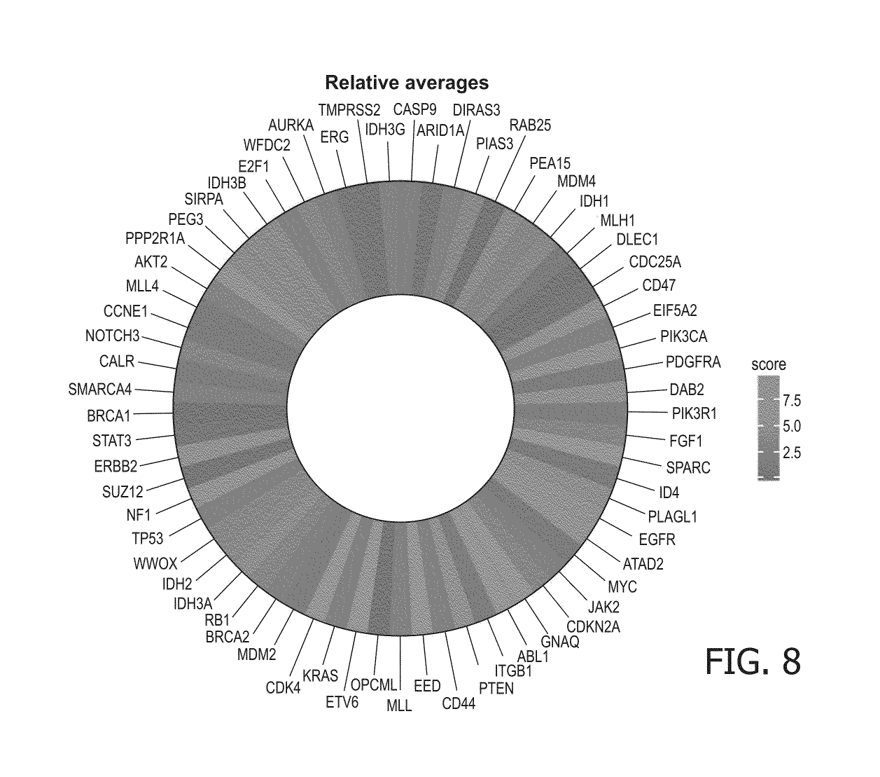

Multiple heat maps can be displayed together in, e.g., a grid manner (not shown), and statistical functions may be applied to generate new heat maps highlighting important differences within or between subgroups. For example, FIG. 8 illustrates the differential expression between the two subgroups in FIGS. 6 and 7. The averages were taken for each gene across both subgroups and subtracted; one of ordinary skill will note that patients who responded positively had higher expression values in ERBB2, PPP2R1A, and EGFR.

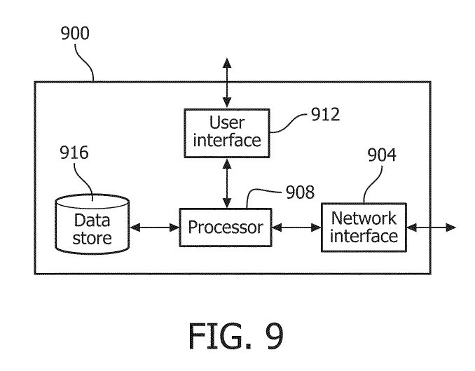

FIG. 9 depicts an exemplary embodiment of the present invention. A user operates a workstation 900 programmed to implement the methods of the present invention such as a desktop computer or a laptop computer, although any device with a suitable interface and network connectivity such as a smartphone or tablet can be used. The network interface 904 allows the workstation 900 to receive communications from other devices and, in one embodiment, provides a bidirectional interface to the Internet. Suitable network interfaces 904 include gigabit Ethernet, Wi-Fi (802.11a/b/g/n), and 3G/4G wireless interfaces such as GSM/WCDMA/LTE that enable data transmissions between workstation 900 and other devices. A processor 908 generates communications for transmission through the interface 904 and processes communications received through the interface 904 that originate outside the workstation 900. A typical processor 908 is an x86, x86-64, or ARMv7 processor, and the like. The user interface 912 allows the workstation 900 to receive commands from and provide feedback to an operator, for example, in connection with specification of a window size and/or a threshold for variability. Exemplary user interfaces include graphical displays, physical keyboards, virtual keyboards, etc. The data store 916 provides both transient and persistent storage for data received via the interface 904, data processed by the processor 908, and data received or sent via the user interface 912.

Various embodiments of the present invention are suited to a variety of applications. These applications include:
the presentation of individual transcriptomes as transcription karyograms within a single patient;
visualizing multiple genome-wide tracks of gene expression, methylation, and/or copy number data for a single patient to give a view of the genomic architecture and the transcriptional readout for a single patient;
layering information so as to present architectural as well as functional info;
visualizing cohorts according to clinical questions and contextualizing single patients within these cohorts;
presenting differential pathways within a single patient over time (e.g., before and after therapy);
presenting continuous temporal information over the course of time or throughout therapy in order to convey how the patient is responding to therapy;
presenting genomewide pathway information within a single patient or across patients; and
presenting genome-wide information across different clinical studies, across patients from different hospitals, or across different regimens of pathway activity levels in patients, and these pathway activity levels can then be used to differentiate one patient from another.

Embodiments of the present disclosure, for example, are described above with reference to block diagrams and/or operational illustrations of methods, systems, and computer program products according to embodiments of the present disclosure. The functions/acts noted in the blocks may occur out of the order as shown in any flowchart. For example, two blocks shown in succession may in fact be executed substantially concurrent or the blocks may sometimes be executed in the reverse order, depending upon the functionality/acts involved. Additionally, not all of the blocks shown in any flowchart need to be performed and/or executed. For example, if a given flowchart has five blocks containing functions/acts, it may be the case that only three of the five blocks are performed and/or executed. In this example, any of the three of the five blocks may be performed and/or executed.

The description and illustration of one or more embodiments provided in this application are not intended to limit or restrict the scope of the present disclosure as claimed in any way. The embodiments, examples, and details provided in this application are considered sufficient to convey possession and enable others to make and use the best mode of the claimed embodiments. The claimed embodiments should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the general inventive concept embodied in this application that do not depart from the broader scope of the claimed embodiments.

What is claimed is:

1. A method for visualizing genomic data, the method comprising:
applying a function to a plurality of genomic values, the application of the function resulting in a plurality of range values;
associating a value for output purposes with each range value; and
displaying the associated values for output purposes in a graphical representation.

2. The method of claim 1 wherein the graphical representation is selected from the group consisting of a karyogram; a chromosome-wide display of RNA-seq expression and methylation data; and a radial heatmap.
